(19) United States
(12) Patent Application Publication
(10) Pub. No.: US 2022/0321767 A1
(43) Pub. Date: Oct. 6, 2022

(54) Self-service kiosk for producing ID photographs with automatic background replacement

(71) Applicants: Carlos Alberto Barros Gonzalez Sr., Wood Land Hills, CA (US); Aleksandr Morozov Sr., Woodland Hills, CA (US)

(72) Inventor: Aleksandr Morozov, San Cugat del Valles (ES)

(21) Appl. No.: 17/220,754

(22) Filed: Apr. 1, 2021

(51) Int. Cl. H04N 5/232; G03B 27/00; G03B 15/00

(52) U.S. Cl. CPC H04N 5/23216; H04N 5/23222; G03B 27/00; G03B 15/00

(57) ABSTRACT

Apparatus and method for generating and printing of photographs for identification documents, which allow you to print photographs for identification documents with a plain color background without using a plain color background during photographing the user, or using an uploaded photograph with an arbitrary background. The apparatus may include one or more cameras configured to photograph the user. The apparatus may include one or more video displays and devices for user interaction. The apparatus may include one or more payment devices. A user takes or uploads a photo with an arbitrary background and position of a person, after which automatic algorithms process the photo, converting it to the required format, including a plain color background, and the correct position of the person. The generated photo then can be printed and/or saved and/or sent to the user using one of the communication channels.

### BACKGROUND OF THE INVENTION

### 1. Field of the Invention

This invention generally relates to the art in the field of photography, and more specifically to an apparatus that allows the generating and printing of photographs for identification documents with a plain color background without the use of a closed space photo booth and/or a plain color background during the taking of the photo.

### 2. Description of the Related Art

Often people are required to obtain a portrait photograph for official use, in most cases the requirements for these photographs are precisely regulated, including, as a rule, it is required that the photograph be taken against a plain color background. At the moment, for these purposes, as a rule, closed space photo booths are used, which include a camera and a plain color background for photographing.

There is a wide variety of self-service photo booths for creating and printing ID photos. Some of these devices are described in patents: US 2009/0076924 A1, US 2002/0093568A1, U.S. Pat. No. 6,298,197 B1, US 2004/0179233 A1 and many others. All of them include a monochrome plain color background against which the user is photographed, or they do not have the ability to print photos with a plain color background. As a result, the booths have a relatively large size or limited functionality, require a large free area for installation and are not suitable for use in most premises.

### SUMMARY OF THE INVENTION

The present invention is directed to an apparatus that is capable of producing photographs for identification documents with the required characteristics, comprising those with a plain color background, without using a plain color background when photographing a user, or using a user-uploaded photo with an arbitrary background as an image source.

The apparatus may include a camera, a computing device, a video display and an input device for interacting with a user, one or more payment acceptance devices.

Unlike the existing self-service photo booths, the device does not need a plain color background for photographing, and it can also be implemented in a relatively compact body.

The device displays on the video display the instructions necessary to work with it, prompting the user to select a source of the image, characteristics required for the desired photograph or the desired field of application for photography. May give instructions on the required pose for photographing. May accept payment from the user, may print required size photos. It may save or send the generated image using communication channels. Special algorithms convert the image received from the camera or uploaded by the user to the format of the required field of application of the photo, or to the format selected by the user.

### BRIEF DESCRIPTION OF THE DRAWINGS

The invention will now be described further by way of example only and with reference to the accompanying drawings in which:

FIG. 1. Appearance of one of the possible implementations of the apparatus.

FIG. 2. The internal structure of one of the possible implementations of the apparatus.

FIG. 3. Provides an example of analyzing the input image and generating a portrait image with the required characteristics.

FIG. 4. Side view illustrating the change of the angle of photographing in accordance with the height of the user.

FIG. 5. A flowchart showing the procedure for a user to operate the machine.

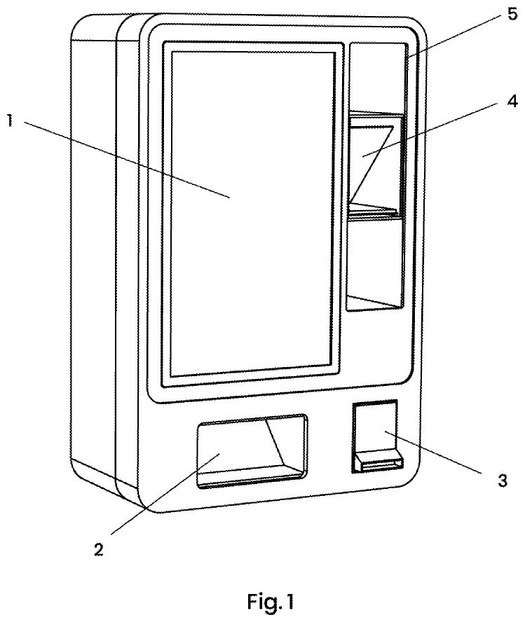

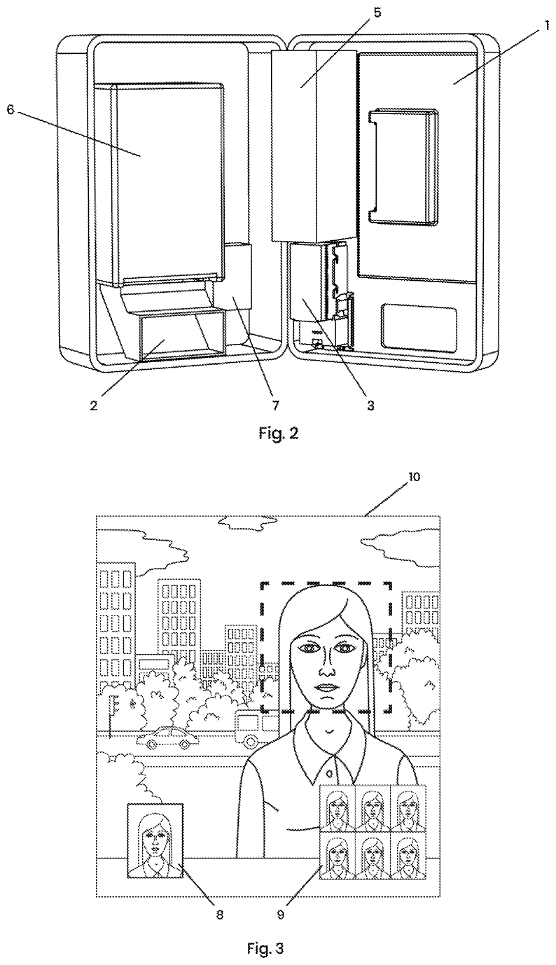

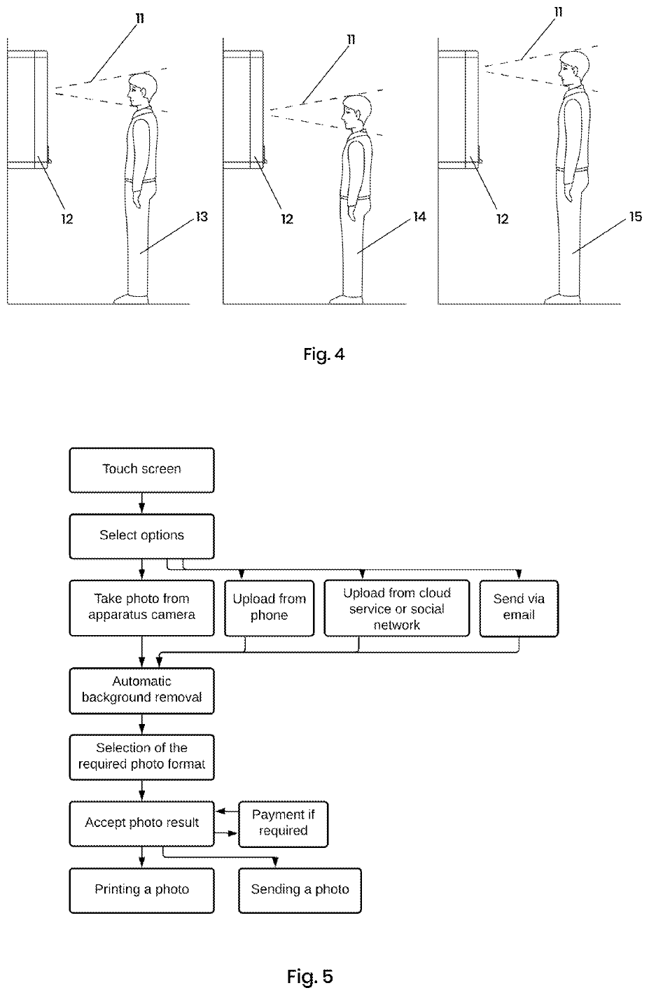

### DETAILED DESCRIPTION OF THE INVENTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

One of the possible implementations of the device may include a monitor combined in a single body with a video display or touch screen for user interaction (1), a box for issuing photographs, into which photographs fall after printing (2), a device for receiving payment from the user (3), a sensor configured to capture an image (4), a mechanism for moving the sensor in height (5), a printer for printing photographs (6), a computing device and a modem for communication (7).

The apparatus may be placed on a wall, table, special stand, or otherwise installed.

The apparatus is mainly intended for printing photographs for identification documents, and differs from existing solutions in that it does not require a plain color background for photographing, the apparatus does not include a closed space cabin or booth, or any monochromic plain color background against which the user should be placed, the user may be photographed with an arbitrary background (10), or upload an image with an arbitrary background, after that an image identification module uses special software located in the device's memory or on a remote server, using automatic algorithms, separates the portrait image of a person from the background and replaces the arbitrary background with the required plain color background (8). As an algorithm for separating the background from the portrait of a person could be used, algorithms of semantic segmentation, algorithms for separating the background based on algorithms for detecting motion, algorithms for constructing a depth map of the scene, or any other possible ways of automatically separating a portrait image of a person from the background may be used. Also, the person's portrait may be centered according to the required specification of identification document, and multiple copies of the required size are placed on a sheet of paper to print (9).

A plain color background means an image that can be used as a background in accordance with the requirements for identification document photographs.

In addition, the apparatus may also have the functions of a self-service photo printer, and print photos with or without processing from various sources.

The apparatus may be equipped with a device (5) to automatically change the angle of the direction of photographing (11) vertically, by moving the camera, or a mirror surface, or the entire device. The software analyzes the image coming from the camera, and using special algorithms makes a decision to vertically move the angle of the direction of photographing (11), after that the mechanism adjusts the angle of the direction of photographing (11) to the required level. Thus, users with different heights (13, 14, 15) can obtain a photograph using the apparatus (12), taken with the correct angle of the direction of photographing (11) relative to the height of the user.

FIG. 5. shows one of the possible ways of interacting with the device. First, a user selects the desired source of the photo: the camera of the apparatus, uploading from the phone, from social networks, cloud storage of photos, sending via email or instant messengers, or in another way. Then special algorithms separate the portrait of a person and an arbitrary background in the original image, replacing the arbitrary background with a plain color background according to the required specification. Then the user has the opportunity to select the required photo format, and according to the required specifications, an image corresponding to the format required for the document will be generated, available to print or send via communication channels. After payment, if required, the generated image can be printed or sent by a module for sending the image via communication channels. Payment, if required, may be made both using one of the payment devices and using one of the electronic payment systems.

The apparatus is a significant development of self-service photo booths used for photographing identification documents. Refusal to use a plain color background makes it possible to abandon a cumbersome closed space structure, significantly reduce the dimensions of the apparatus, and reduce the cost of operation. It becomes possible to install the device in places where it is impossible to install a traditional self-service photo booth.

The disclosed embodiments are illustrative, not restrictive. While specific configurations of the technology have been described, it is understood that the present invention can be applied to a wide variety of technologies. There are many alternative ways of implementing the invention.

1. An apparatus for producing ID photographs, comprising:
a sensor configured to capture an image;
a video display; and
an image identification module consisting of one or more processors configured to generate from the captured image comprising the image with an arbitrary background, without a chroma key or any special background, and an arbitrary position of a person obtained from the sensor a generated image with a plain color background and a portrait position according to specification of ID photographs to display on the video display.

2. The apparatus for producing ID photographs as recited in claim 1, further comprising:
a touch screen docked to the video display for user interaction.

3. The apparatus for producing ID photographs as recited in claim 2, further comprising:
a printer for printing the image obtained from the image identification module.

4. The apparatus for producing ID photographs as recited in claim 2, further comprising:
a module for sending the image received from the image identification module via various electronic communication channels.

5. The apparatus for producing ID photographs as recited in claim 3, further comprising:
a mechanism used to vertically change the position of the angle of photographing of the sensor configured to capture an image.

6. The apparatus for producing ID photographs as recited in claim 4, further comprising:
a mechanism used to vertically change the position of the angle of photographing of the sensor configured to capture an image.

7. The apparatus for producing ID photographs as recited in claim 5, further comprising:
a payment module containing one or more payment devices to start a printing process on the printer.

8. The apparatus for producing ID photographs as recited in claim 4,
wherein the module for sending the image is configured to send photos to the destination that requests an ID photograph.

9. The apparatus for producing ID photographs as recited in claim 1, wherein the photo may be uploaded to the image identification module from a phone, or from social networks, or cloud photo storages, or sent via email or instant messengers.

10. A method of photographing a person with an arbitrary background and obtaining photographs with a plain color background according to specification for ID photographs, the method comprising:
retrieving an input image with an arbitrary background from a sensor configured to capture an image;
separating an image of a person from an arbitrary background in the input image;
creation of a generated image comprising the image of a person and a plain color background according to specification for ID photographs; and
displaying the generated image on a video display.

11. The method of claim 10, further comprising:
vertically changing to an angle of photographing of a sensor configured to capture an image in accordance with the person's height.

12. The method of claim 10, further comprising:
creating a generated image comprising of one or more copies of portrait images on a plain color background.

13. The method of claim 12, further comprising:
printing the generated image.

14. The method of claim 10, further comprising:
sending the generated image via communication channels.
